(19) United States
(12) Patent Application Publication
(10) Pub. No.: US 2011/0187194 A1
(43) Pub. Date: Aug. 4, 2011

(54) EMERGENCY POWER SUPPLY SYSTEM COMPRISING A FUEL CELL

(75) Inventors: Marcus Keimling, Oberursel (DE); Jens Gommermann, Hofheim (DE); Christian Eller, Kronberg (DE)

(73) Assignee: FRAPORT AG FRANKFURT AIRPORT SERVICES WORLDWIDE, Frankfurt am Main (DE)

(21) Appl. No.: 12/989,390

(22) PCT Filed: Apr. 15, 2009
(86) PCT No.: PCT/EP09/02764

§ 371 Date: Apr. 19, 2011

(30) Foreign Application Priority Data
Apr. 23, 2008 (DE) 102008020356.4

(51) Int. Cl. H02J 9/06; H01M 8/04

(52) U.S. Cl. 307/65; 429/429; 307/64

(57) ABSTRACT

An emergency power supply system for a load connected to an AC grid (normal grid) includes a fuel cell for generating direct current, an inverter for providing alternating current, and a controller. The controller includes a synchronizing means which synchronizes the current provided by the inverter in phase with the current of the AC grid. The emergency power supply system hence is able to again provide the normal grid to the loads without further interruption.

This invention relates to an emergency power supply system for a load connected to an AC grid, comprising a fuel cell for generating direct current, an inverter for providing alternating current, and a controller.

Emergency power supply systems are used to maintain the supply of safety-relevant or other important loads with electric energy in the case of a failure of the AC grid to which the loads normally are connected (normal grid). For an emergency supply of several and/or larger loads Diesel generators are used, for example. With regard to diminishing fossil fuels, emergency power supply systems with hydrogen-operated fuel cells are developed, which have a number of advantages as compared to Diesel generators, for example that no CO₂ is emitted during the operation.

A fundamental problem with the use of conventional emergency power supply systems consists in that after recovery of the normal grid the power supply of the loads must again be interrupted, since the current supplied by the emergency power supply system is not synchronous with the current of the normal grid.

It is the object of the invention to make the emergency power supply of AC grid loads more beneficial to the environment, more comfortable and as loss-free as possible, in particular with respect to switching back the loads from the emergency power supply system to the recovered AC grid.

This object is solved by an emergency power supply system with the features of claim 1. Advantageous and expedient aspects of the emergency power supply system of the invention can be taken from the sub-claims.

The emergency power supply system of the invention is characterized in that the controller includes a synchronizing means which synchronizes the current provided by the inverter so as to be in phase with the current of the AC grid, which subsequently will be referred to as “load-synchronous switch-back”. This invention is based on the finding that switching back the loads from the emergency power supply system to the recovered AC grid can be effected without interruption, when it is ensured that the current delivered by the emergency power supply system is synchronous with the current of the recovered normal grid. Beside the benefits of the fuel cell, the emergency power supply system of the invention with the synchronizing means provided for this purpose thus offers the additional advantage that in the case of a power failure only a single interruption is effected, namely before switching to the emergency power supply, but no further interruption when switching back to the normal grid.

Further features and advantages of the invention can be taken from the following description and from the attached drawings, to which reference is made and in which:

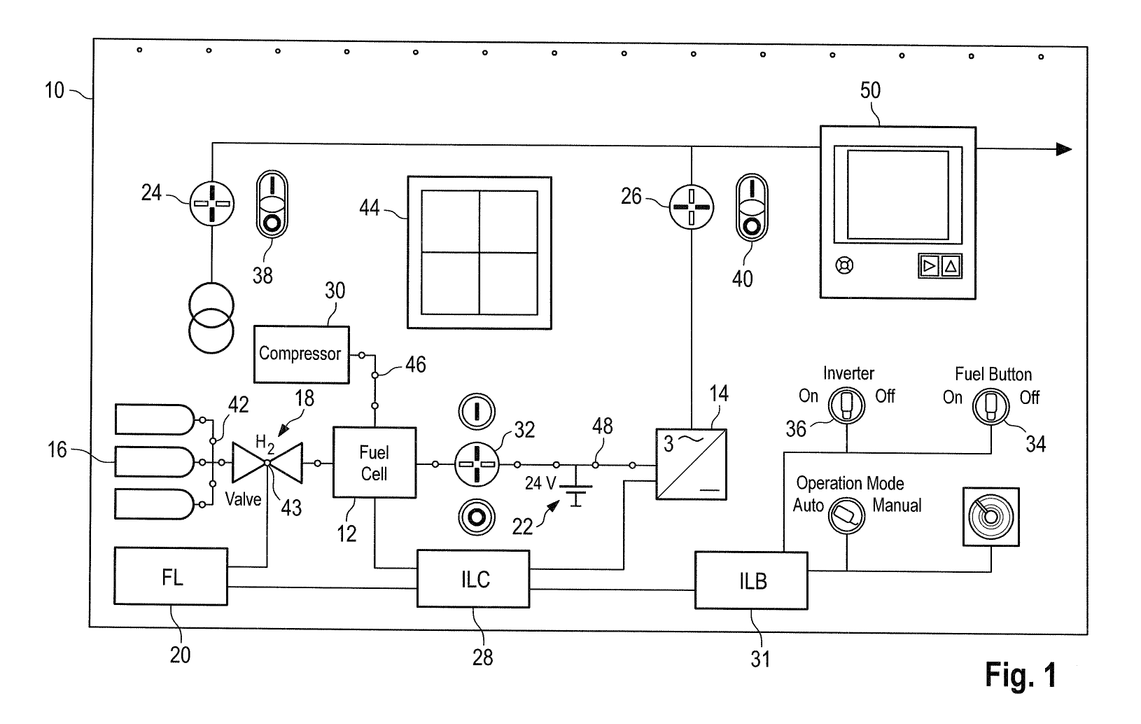

FIG. 1 shows the control panel of an emergency power supply system of the invention;

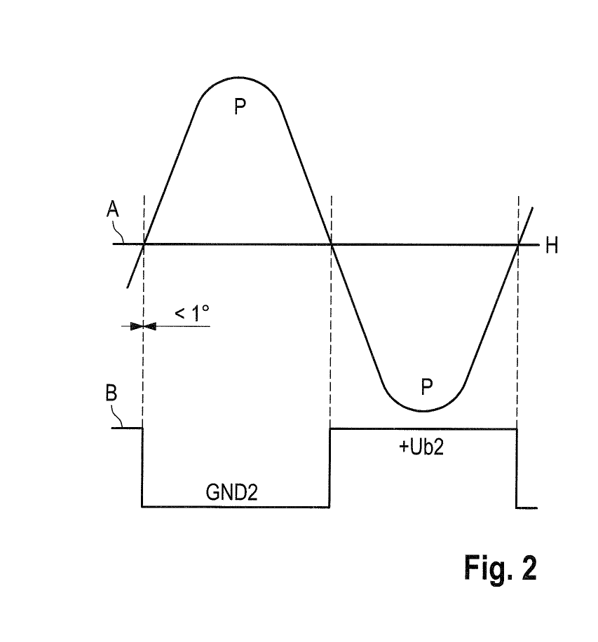

FIG. 2 shows the generation of a synchronizing signal by the synchronizing means;

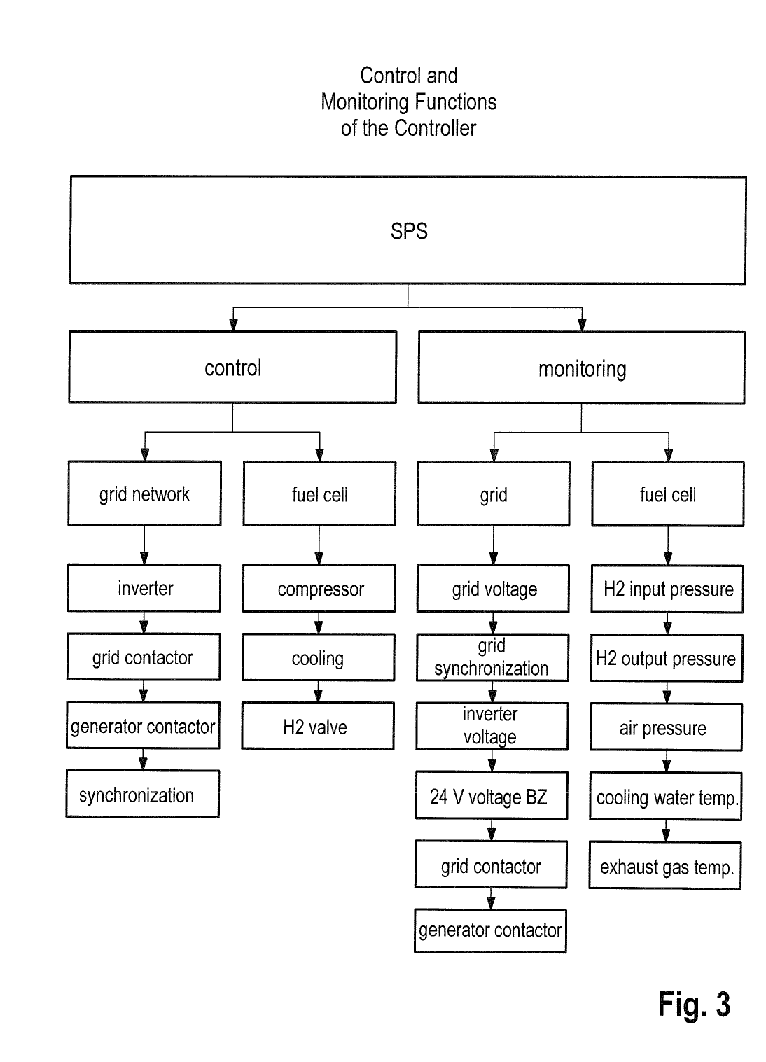

FIG. 3 shows a schematic diagram of the control and monitoring functions of the controller;

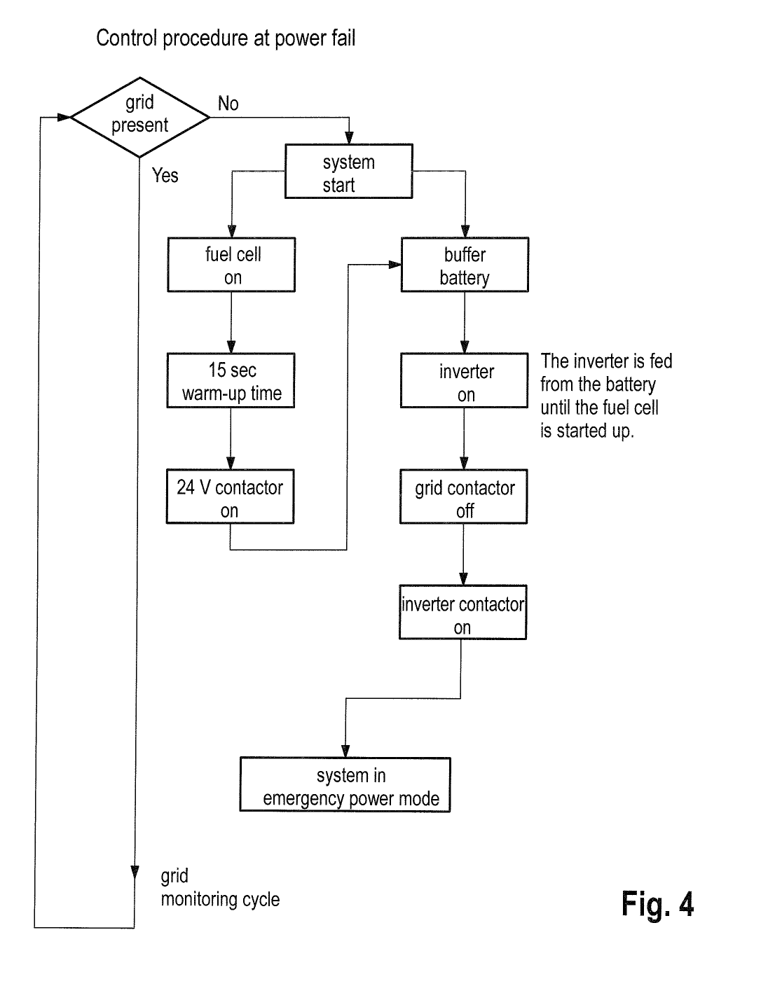

FIG. 4 shows a control procedure upon failure of the normal grid; and

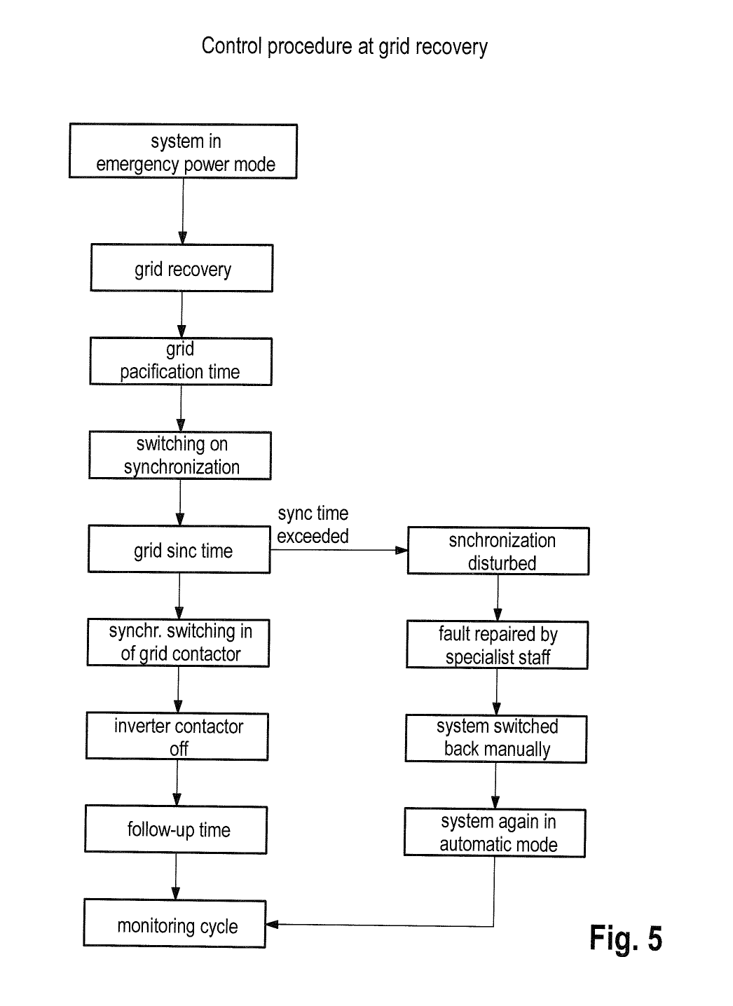

FIG. 5 shows a control procedure upon recovery of the normal grid.

By way of example, there is described the structure of an emergency power supply system of the invention for alternatively providing a solid three-phase grid for use in a building. The emergency power supply system is intended to again supply loads which are connected to a normal AC grid (normal grid) with alternating current as quickly as possible in the case of a failure of the normal grid. FIG. 1 shows the control panel 10 of the emergency power supply system with a schematic circuit diagram to which reference will be made below.

The energy source of the emergency power supply system preferably is a PEM (polymer electrolyte membrane) fuel cell 12 with a fuel cell stack which generates direct current in operation of the emergency power supply system. Via an inverter 14, the direct current is converted into alternating current and transformed to the voltage of the AC grid.

The emergency power supply system is divided into three parts, which in the installed condition of the emergency power supply system are spatially separated from each other. Such (or a similar) separation of the system components is advantageous for the above-mentioned purpose, but not absolutely necessary for the function of the emergency power supply system.

The first part comprises a plurality of metal hydride storage tanks 16 and a hydrogen supply module 18 with pressure sensors, a mechanical pressure reducer, pressure relief valves and a hydrogen main valve. The hydrogen supply module 18 safely delivers hydrogen from the metal hydride storage tanks 16 to the fuel cell 12. The hydrogen supply module 18 is controlled by a field bus coupler 20 which is connected with a main controller of the emergency power supply system via a bus system (Profinet). Furthermore, the first part of the emergency power supply system also comprises two control energy accumulators in the form of rechargeable batteries (2×12 volt in series=24 volt) with a charging device. The control energy accumulators are provided to deliver the energy for controlling the emergency power supply system during an interruption of the normal grid. Furthermore two load energy accumulators 22 are provided (buffer batteries, preferably same structure as the control batteries, likewise with a charging device). The load energy accumulators 22 serve as energy buffer for the time between the failure of the normal grid and the stable operation of the fuel cell 12. Via a circuit with diodes (Schottky diodes), the load energy accumulators 22 also intended to absorb load impulses which might overload the fuel cell. In principle, correspondingly designed capacitors can also be provided as load energy accumulators.

In the second part of the emergency power supply system the fuel cell 12 is mounted with an electronic pressure reducer and a clock valve. The clock valve serves for cleaning the anode side of the fuel cell 12 and thus for protection against water deposits. The second part furthermore comprises the main controller of the emergency power supply system, which includes a plurality of circuit breakers, a grid contactor 24 and an inverter contactor 26 for switching between normal grid and emergency grid, a plurality of relays, a synchronization lock-up relay, a memory-programmable control unit 28 (SPS) and a zero-crossing detection unit in the form of a zero-crossing board. In addition, the second part comprises the inverter 14 (here a three-phase sine inverter). By means of a signal of the zero-crossing detection unit, the same can synchronize the emergency grid in phase with the normal grid, which will be explained in more detail below.

The third part of the emergency power supply system contains a cooling system for the fuel cell and an air compressor 30 which delivers the oxygen required for the chemical reaction in the fuel cell. The control panel 10 also belongs to the third part. Beside the operation of the emergency power supply system, the control panel 10 also serves for detecting switching conditions and disturbances. The components of the third part likewise are controlled via a field bus coupler 31 connected to the bus system.

Subsequently, the operation of the emergency power supply system will be described. Three operating modes are provided: Automatic Mode, Blocked and Manual Mode.

In the Automatic Mode a grid or phase monitor of the emergency power supply system constantly monitors the normal grid. If the voltage breaks down or the normal grid fails completely at some time, the grid or phase monitor emits a signal to the controller, whereupon a program for starting the emergency power supply system is executed. In this program sequence, the inverter 14 and the fuel cell 12 are started at the same time. The inverter 14, fed from the load energy accumulators 22, immediately starts to generate a 400 volt three-phase grid. As soon as this three-phase grid is available (period <1 s), the controller switches off (connection separated) the grid contactor 24 (contactor between normal grid and loads) and switches in (connection established) the inverter contactor 26 (contactor between inverter and load). The connected loads now are temporarily supplied with energy from the load energy accumulators 22, with their direct current being converted into alternating current by the inverter 14.

At the same time, the fuel cell 12 is put into operation by starting the cooling water supply, switching on the compressor 30 for the air supply and opening the hydrogen main valve of the hydrogen supply module 18. As soon as the fuel cell 12 supplies its output voltage of at least 24 volt, a DC voltage monitor emits a signal to the controller. After a set warm-up time, a DC voltage contactor 32 switches the fuel cell voltage to the inverter 14. From this time, the fuel cell 12 directly supplies the inverter 14 and thus also the loads.

Upon recovery of the normal grid, the signal of the grid or phase monitor is set back. After expiration of a time interval, the so-called grid pacification time, in which further grid fluctuations might lead to undesired increased starting currents for the loads, a relay is switched on, which controls the zero-crossing detection unit. The zero-crossing detection unit now starts to send a signal to the inverter 14. This signal is digital and comprises voltage pulses with an amplitude of e.g. 5 volt. With every positive zero crossing of the normal grid (strictly speaking with every positive zero crossing of the voltage curve of the normal grid, alternatively also of the current curve), the zero-crossing detection unit delivers a characteristic signal pulse, e.g. a “negative flank”, which is processed by the inverter 14. The zero-crossing detection unit does not include a transformer, so that the phase shift between the analog input signal (grid voltage of the recovered normal grid) and the digital output signal is almost zero (<1°). The inverter 14 now starts to synchronize with the signal of the zero-crossing detection unit.

The inverter 14 indicates (e.g. by means of an LED) whether it has synchronized with the signal supplied to the same. If this is the case, a synchronization monitoring relay thereupon compares the phase conductors L1 and L2 of the normal grid with the phase conductors L1 and L2 of the inverter 14. If these are synchronous, a contact is closed and a signal is output to the controller. This sync message as well as the switch position indication for the normal grid are displayed on the control panel 10. If the normal grid and the emergency grid are synchronous for a set period, both grids are switched on each other for a short period (grid contactor 24 and inverter contactor 26 are switched in), before the inverter contactor 26 is shut off, so that an uninterrupted synchronous transition is ensured. Now, the loads again are supplied with voltage from the normal grid.

After switching back, the fuel cell 12 and the inverter 14 still operate synchronous to the normal grid for a certain time, until they are shut off. The emergency power supply system now again is in the monitoring mode.

In the operating mode Blocked the start-up and all switching actions of the automatic function and of the connected control system are blocked.

In the Manual Mode the emergency power supply system can be put into operation manually. In this operating mode, the emergency power supply system does not switch automatically corresponding to the program sequence in the controller, but the operator is able to control each step individually at the control panel 10. Thus, it is possible for the operator to switch the fuel cell 12 and the inverter 14 on and off by using step switches 34 and 36. For safety reasons, the fuel cell 12 has the same warm-up time as in the automatic mode, and the controller ensures that switching in the DC voltage contactor 32 only is possible after this time. The DC voltage contactor 32 can be switched on and off manually.

In the manual mode, grid-synchronous switching is not possible. The switches 38 and 40 for the grid contactor 24 or the inverter contactor 26 are locked against each other, i.e. both switches 38, 40 must be “OFF” to allow that one of the switches can be switched on. In this way, it is prevented that the two grids are switched on each other asynchronously and a possible damage is produced for the load.

In the following, the synchronization will be explained again, which is effected before switching back from the emergency grid to the recovered normal grid. The zero-crossing detection unit in the form of the zero-crossing board is a special development, i.e. no standard component. Since the inverter 14 is selectively influenced by the signal of the zero-crossing detection unit, the inverter 14 is able to synchronize very quickly. For this purpose, a microcontroller of the inverter 14 is programmed such that it is synchronized with an external signal. The emergency power supply system thus can be used in any AC grid (e.g. in the USA), since the inverter 14 generally is synchronized with the delivered signal of the zero-crossing detection unit. Those components of the controller (including the microcontroller of the inverter) which provide for the above-described load-synchronous switch-back are referred to as synchronizing means.

For a better understanding, FIG. 2 shows the output of the synchronizing signal. It can be seen that in the case of a zero crossing from the negative to the positive half-wave of the characteristic curve A a negative flank is delivered at the characteristic curve B.

The control panel 10 shown in FIG. 1 with various switches and optical displays also indicates the basic circuit diagram of the integrated emergency power supply system beside the switch positions, pressures, disturbances, operating variables and messages—as mentioned already. In the following, a few important switches and indications of the control panel 10 will briefly be explained.

Switch position indications for the lines switched or interrupted by means of the contactors 24, 26 and 32 are green when switched off and red when switched on.

The switches 38 and 40 only are available in the manual mode. By means of these switches grid and inverter contactor 24, 26 can be switched manually. Since the switches 38, 40 are locked against each other in the manual mode, a lamp in the middle of the switches lights up, when the same can be actuated.

Blue LEDs 42 indicate that the input pressure at the hydrogen supply module 18 is sufficient.

An LED 43 in the hydrogen supply module 18 indicates the condition of the hydrogen main valve. If the LED lights up red, the valve is closed, if it lights up green, the valve is switched through and supplies the fuel cell 12 with hydrogen.

A display panel 44 indicates status and fault messages. Status messages include in particular:
normal grid present;
normal grid and emergency grid in synchronism;
inverter in operation;
fuel cell in operation.

Fault messages include in particular:
normal grid missing;
synchronization disturbed;
inverter disturbed;
fuel cell disturbed;
charging devices disturbed;
emergency stop.

The LEDs 46 indicate that the air input pressure of the fuel cell 12 is present.

Red LEDs 48 indicate that the fuel cell voltage is applied to the inverter.

A multifunction display device 50 indicates the voltages and currents at the output of the emergency power supply system.

The basic functions of the controller are shown in FIGS. 3, 4 and 5 in a simple schematic diagram and simple flow diagrams. The program executed in the control unit 28 of the controller consists of several function blocks for contactors and operating modes. In addition, it consists of auxiliary function blocks, such as a freely adjustable flasher, a setting pulse and a temperature module. FIG. 3 shows the most important control and monitoring functions. FIGS. 4 and 5 illustrate the normal grid failure and the switch-back from the emergency grid to the normal grid.

Since the structure of the emergency power supply system with the synchronizing means provided in accordance with the invention not only provides for a load-synchronous switch-back, but also for a load-synchronous “switch-on” (from the normal grid to the emergency grid), the emergency power supply system involves the advantage that test runs and maintenance work can be performed without the loads being influenced thereby.

1. An emergency power supply system for loads connected to an AC grid, comprising
a fuel cell for generating direct current,
an inverter for providing alternating current, and
a controller,
characterized in that the controller includes a synchronizing means which synchronizes the current provided by the inverter so as to be in phase with the current of the AC grid.

2. The emergency power supply system according to claim 1, characterized in that the controller includes a zero-crossing detection unit which with every zero crossing of the voltage or current curve of the AC grid outputs a characteristic signal pulse to the inverter.

3. The emergency power supply system according to claim 2, characterized in that upon recovery of the AC grid the zero-crossing detection unit is activated only after expiration of a grid pacification time.

4. The emergency power supply system according to claim 2, characterized in that the inverter is designed such that by including a programmable microcontroller the inverter synchronizes the alternating current emitted by the same with the signal of the zero-crossing detection unit.

5. The emergency power supply system according to claim 1, characterized in that the controller effects a switch-back of the loads from the current of the inverter to the current of the AC grid only after expiration of a set time interval in which both currents are synchronous.

6. The emergency power supply system according to claim 5, characterized in that during switch-back both synchronous currents briefly are switched onto the loads at the same time, before the loads are separated from the inverter.

7. The emergency power supply system according to claim 1, characterized by first energy accumulators for providing energy to the controller during a failure of the AC grid.

8. The emergency power supply system according to claim 1, characterized by second energy accumulators for providing energy for the loads during the activation of the fuel cell.

9. The emergency power supply system according to claim 8, characterized in that after detecting a failure of the AC grid the controller activates the inverter and the fuel cell at the same time.

10. The emergency power supply system according to claim 9, characterized in that before a specified output voltage of the fuel cell is available, the inverter is fed with direct current of the second energy accumulators.

11. The emergency power supply system according to claim 1, characterized in that in a manual operating mode an operator can switch the fuel cell and the inverter on and off, wherein switching the direct current of the fuel cell to the inverter is possible only after a warm-up time.

12. The emergency power supply system according to claim 1, characterized by a safety means which in a manual operating mode prevents that the loads are simultaneously connected to the AC grid and to the inverter.

13. The emergency power supply system according to claim 1, characterized in that it also provides for a load-synchronous switching from the alternating current of the AC grid to the alternating current of the current provided by the inverter (emergency grid).

14. The emergency power supply system according to claim 13, characterized in that the synchronizing means synchronizes the current of the AC grid so as to be in phase with the current provided by the inverter.

15. The emergency power supply system according to claim 3, characterized in that the inverter is designed such that preferably by including a programmable microcontroller the inverter synchronizes the alternating current emitted by the same with the signal of the zero-crossing detection unit.

16. The emergency power supply system according to claim 2, characterized in that the controller effects a switch-back of the loads from the current of the inverter to the current of the AC grid only after expiration of a set time interval in which both currents are synchronous.

17. The emergency power supply system according to claim 2, characterized by first energy accumulators for providing energy to the controller during a failure of the AC grid.

18. The emergency power supply system according to claim 2, characterized by second energy accumulators for providing energy for the loads during the activation of the fuel cell.

19. The emergency power supply system according to claim 2, characterized in that in a manual operating mode an operator can switch the fuel cell and the inverter on and off, wherein switching the direct current of the fuel cell to the inverter is possible only after a warm-up time.

20. The emergency power supply system according to claim 2, characterized by a safety means which in a manual operating mode prevents that the loads are simultaneously connected to the AC grid and to the inverter.
